(19) United States
(12) Patent Application Publication
(10) Pub. No.: US 2024/0318397 A1
(43) Pub. Date: Sep. 26, 2024

(54) LOST FORMWORK FOR GUIDE WALL FOR PILE WALL CONSTRUCTION

(71) Applicant: ADB SYSTEM, PONTOISE (FR)

(72) Inventor: Adrien HEMET, PONTOISE (FR)

(21) Appl. No.: 18/573,571

(22) PCT Filed: Jun. 23, 2022
(86) PCT No.: PCT/EP2022/067220

§ 371 Date: Dec. 22, 2023

(30) Foreign Application Priority Data
Jun. 23, 2021 (FR) FR2106699

(51) Int. Cl. E02D 5/20; E02D 5/18; E02D 5/38; E02D 5/68

(52) U.S. Cl. CPC E02D 5/20; E02D 5/182; E02D 5/38; E02D 5/68

(57) ABSTRACT

A method for manufacturing a one-piece element defining a lost formwork for forming drill guides, includes mixing a volume of hydraulic binder including a first volume of water and a second volume of a bonding element and a volume of an organic base; molding to obtain a one-piece element including at least one cylindrical portion with a radius of at least 40 cm; drying the mixture molded forming a one-piece element, and recessing a central portion of material of the one-piece element in a central zone of the cylinder portion to form a guide.

### FIELD OF THE INVENTION

The field of the invention is directed to devices for positioning and guiding augers or industrial drills in the ground to position and stabilize pile walls.

### PRIOR ART

Currently, in large building works made in the construction industry, a solution used is to form retaining structures formed by piles. These structures enable the land to be retained. The piles of such a retaining structure are positioned in the ground and are held by needle beams once the earth has been excavated in such a way as to form retaining lines of a zone to be built. The pile is a construction element that can be chosen from concrete, steel, wood or a mixed assembly. These piles are generally used when the land cannot withstand stresses due to the mass of the work on the surface.

The structure obtained is a pile wall formed by vertical pile alignments. Typically, piles in a wall are alternated in two types: primary piles, for example of lean concrete, and secondary piles, for example of reinforced concrete. The secondary piles are arranged so as to intersect the primary piles in order to ensure lateral material continuity.

A well-known problem with poor pile positioning is that it leads to a significant loss of time on a construction site and very complex readjustment maneuvers to implement. A consequence may be a complete reorganization of the construction site schedule. In order to solve the problems related to positioning errors, it is known to design concrete guide walls in which a lost formwork based on polystyrene has made it possible to design openings for receiving piles.

However, this solution requires the removal of polystyrene, which is not an environmentally friendly material. Its removal is complex to implement once the concrete has been poured around its geometry. In addition, parasitic polystyrene elements remain even when removed.

Another problem is that the piles have to be alternated in a wall of secant piles between so-called secondary hard piles, for example of reinforced concrete, and so-called primary soft piles, so that the soft piles are engaged by adjacent hard piles. However, when the polystyrene structures are removed, errors are made in the nature of the pile to be positioned alternately, as no reliable indication is present. For example, two hard piles could be arranged adjacently by error, causing disorganization of the construction site and damage to the structure.

There is a need to find a solution that can guide secant piles precisely, while securing their alternation. Finally, there is a need to find a non-polluting solution that minimizes human operations, especially the treatment of waste resulting from the production of such works.

The invention makes it possible to overcome these drawbacks.

### SUMMARY OF THE INVENTION

According to a first aspect, the invention relates to a method for manufacturing a one-piece element defining a lost formwork for forming a target and/or a drilling guide characterized in that it includes:
Mixing a volume of hydraulic binder including a first volume of water and a second volume of a bonding element with a volume of an organic base;
Molding to obtain a one-piece element comprising at least one cylindrical portion with a radius of at least 40 cm,
Drying said mixture molded forming a one-piece element.
   One advantage of the invention is to make a lost formwork that will be destroyed during the drilling operation. One advantage is to avoid reprocessing the element forming the lost formwork. The invention saves time in the drilling operation.

According to one embodiment, the invention relates to a method for manufacturing a one-piece element defining a lost formwork for forming a target and/or a drilling guide characterized in that it includes:
Mixing a volume of hydraulic binder including a first volume of water and a second volume of a bonding element with a volume of an organic base;
Molding to obtain a one-piece element including at least one cylindrical portion,
Drying said mixture molded forming a one-piece element.

According to one embodiment, the method comprises a step of recessing material from a central portion of the one-piece element in a central zone of the cylinder portion to form a guide. One advantage is to define a grip for the transport of one-piece elements. Another advantage is to insert a strut for stabilizing the one-piece element during the concrete pouring operation to make the accommodating structure.

According to one embodiment, the method comprises a step of cutting the one-piece element, said cutting allowing a predetermined shape to be obtained. One advantage is to standardize size of the mold or at least to reduce the number of molds and to adapt secondly the size of the one-piece element to the case.

According to one embodiment, the method comprises a step of assembling a plurality of one-piece elements together in order to make a guide wall, said one-piece elements including bonding elements in order to secure two ends of two one-piece elements together. One advantage is to make modular one-piece elements that can be assembled in different configurations. According to one embodiment, the end cylindrical profiles of the one-piece element comprise several bonding elements on their circumference so as to enable different assemblies of one-piece elements to be made. A further advantage is to make one-piece components that are easier to transport and handle.

According to one embodiment, molding the one-piece element is performed by means of a mold for forming at least one guide whose centers of the cylindrical portions considered together form a characteristic geometry, such as a line, a curve, a “T” shape or an “L” shape.

According to one embodiment, the adjacent cylindrical portions of a one-piece element are a predefined distance apart, tangent to each other or intersected on a portion of their radius.

According to one embodiment, the mixture comprises:
a volume of water in a volume proportion of the mixture between 15 and 27%;
a volume of lime and/or plaster and/or cement and/or blast furnace slag forming a bonding element in a volume proportion of the mixture between 20% and 40%;
a volume of straw forming an organic base in a volume proportion of the mixture between 45% and 55%.

Advantageously, at the end of the mixing operation, the volume of water has been partly consumed in the setting reaction and another part has evaporated during a drying operation.

According to a slightly wider range, the volume of straw forming an organic base can be selected in a volume ratio of the mixture ranging from 33% to 65%.

According to one embodiment, a mixture offering maximum compactness will be made with a volume of straw greater than 65% of the total volume, for example with 75% of the total volume, 85% of the total volume, or even 95% of the total volume. In the latter cases, the volume of hydraulic binder complements the selected volume of straw, i.e. 25%, 15%, 5% respectively.

All proportions can be reported by weight, e.g. in kilograms, taking account of the density of each of the elements added to the mixture.

According to one embodiment, the method includes a step of coloring each cylindrical profile of a mixture to form a one-piece element having alternating coloration between two adjacent cylindrical profiles. One advantage is that it is possible to reduce errors in the types of piles that are inserted into the drilled cavities.

According to a second aspect, the invention relates to a use of one or more one-piece elements to define a lost formwork, said at least one one-piece element being formed by a mixture of a volume of hydraulic binder comprising a first volume of water and a second volume of a bonding element and a volume of an organic base, said at least one one-piece element forming at least one cylindrical portion, said lost formwork being used to form a concrete accommodating structure for accommodating a pile wall.

According to a third aspect, the invention relates to a use of one or more one-piece element(s) to define a target and a drilling guide, said at least one one-piece element being formed by a mixture of a volume of hydraulic binder comprising a first volume of water and a second volume of a bonding element and a volume of an organic base, said at least one one-piece element forming at least one cylindrical portion, the at least one one-piece element being arranged in a concrete accommodating structure for receiving piles, said drilling being carried out by means of an auger whose head is applied to a surface of the at least one one-piece element.

The use of the invention may also be described as a method for designing a lost formwork of a guide accommodating structure, said lost formwork defining a guide target for drilling. In addition, the lost formwork made it possible to make the accommodating structure.

According to one embodiment, the use of the mixture of the at least one one-piece element used comprises:
a volume of water in a volume proportion of the mixture between 15 and 27%;
a volume of lime and/or plaster and/or cement and/or blast furnace slag forming a bonding element in a volume proportion of the mixture between 20% and 40%;
a volume of straw forming an organic base in a volume proportion of the mixture between 45% and 55%.

According to a fourth aspect, the invention relates to an accommodating structure forming a guide wall for making a pile wall, said accommodating structure comprising a concrete base and cavities, said cavities being occupied by at least one one-piece element formed by a mixture of a volume of a hydraulic binder comprising a first volume of water and a second volume of a bonding element and a volume of an organic base.

According to one embodiment, the mixture of the at least one one-piece element of the accommodating structure comprises:
a volume of water in a volume proportion of the mixture between 15 and 27%;
a volume of lime and/or plaster and/or cement and/or blast furnace slag forming a bonding element in a volume proportion of the mixture between 20% and 40%;
a volume of straw forming an organic base in a volume proportion of the mixture between 45% and 55%.

The invention also relates to a use of a one-piece element to define a lost formwork, said one-piece element being formed by a mixture of a volume of hydraulic binder comprising a first volume of water and a second volume of a bonding element and a volume of an organic base, said one-piece element forming at least a cylindrical portion, said use including forming a concrete accommodating structure for accommodating a pile wall.

The invention also relates to a use of one or more one-piece element(s) to define a target and a drilling guide, said at least one one-piece element being formed by a mixture of a volume of hydraulic binder comprising a first volume of water and a second volume of a bonding element and a volume of an organic base, said at least one one-piece element forming at least one cylindrical portion, said use comprising the arrangement of said at least one one-piece element in a concrete accommodating structure for receiving piles, said drilling being carried out by means of an auger whose head is applied to a surface of said at least one one-piece element.

### BRIEF DESCRIPTION OF THE FIGURES

Further characteristics and advantages of the invention will become clearer upon reading the following detailed description, with reference to the appended figures, that illustrate:

FIG. 1: an example of a wall of secant piles attached in ground openings by means of an accommodating structure of the invention;

FIG. 2: an example of drilling within an opening in the ground whose guidance has been enabled by an accommodating structure of the invention;

FIG. 3: an example of an accommodating structure of the invention comprising a one-piece element;

FIG. 4: an example of an accommodating structure of the invention without a one-piece element;

FIG. 5: a first example of a one-piece element represented in a perspective view of the invention comprising a plurality of cylindrical profiles forming a lost formwork to form an accommodating structure of the invention;

FIG. 6: an example of a one-piece element according to FIG. 4 in a top view of the invention forming a lost formwork to form an accommodating structure of the invention;

FIG. 7: a second example of a one-piece element represented in a perspective view of the invention comprising a plurality of cylindrical profiles forming a bend to form an accommodating structure of the invention;

FIG. 8: an example of a mold for making a one-piece structure of the invention;

FIG. 9: an example of steps of the method for manufacturing a one-piece element of the invention;

FIG. 10: an example of steps of the guided drilling method from an accommodating structure of the invention;

FIG. 11: an example of a one-piece element adapted to guide drilling of a single pile;

FIG. 12: An example of lines of one-piece elements forming an angle to each other around a corner one-piece element.

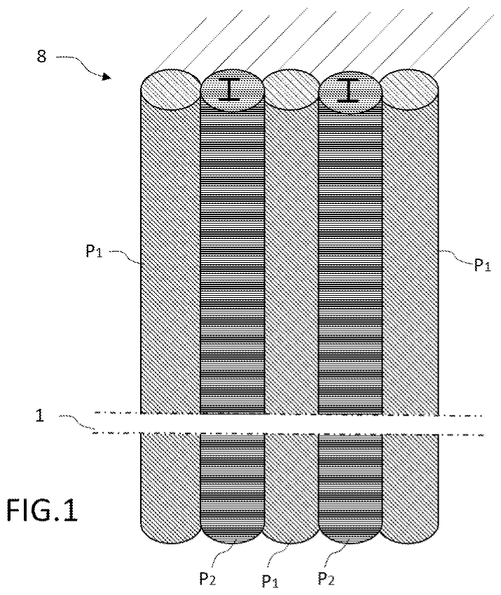

FIG. 1 represents an example of a part of a retaining wall 8 defining a wall of secant piles P₁, P₂. The so-called hard secondary piles P₂ are alternated with so-called soft primary piles P₁. The piles are inserted into cavities defining cylindrical openings made in the ground to hold the same. The piles can have diameters from 30 cm to 1.5 m and in some cases can range below or above this interval. FIG. 1 represents part of the submerged piles held under the ground 1 and another emerged part for defining a projecting wall for building a work on foundation made stable.

Such a retaining structure is obtained by drilling holes 3 in the ground 1 in order to position the piles P₁, P₂.

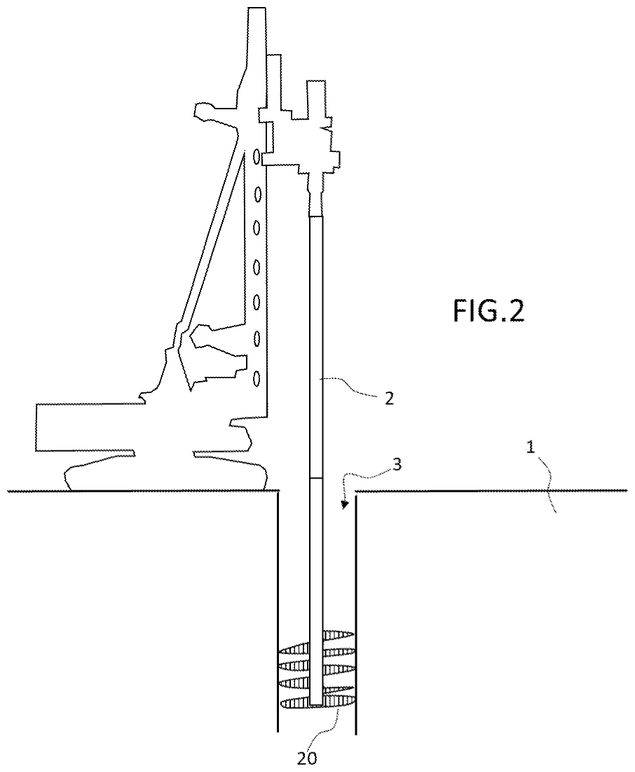

FIG. 2 shows an example of drilling 3 performed using an auger 2, 3 including a handle 2 and a head 20. Generally, the holes are made between a few tens of centimeters and a few meters depending on the ground and the work to be made, which will be retained especially by the retaining structure.

The holes are made in such a way as to define the layout of a wall of secant piles. The layout can define a ground line or an alternation of segments forming angles to each other. Typically, a wall of secant piles can define a right angle.

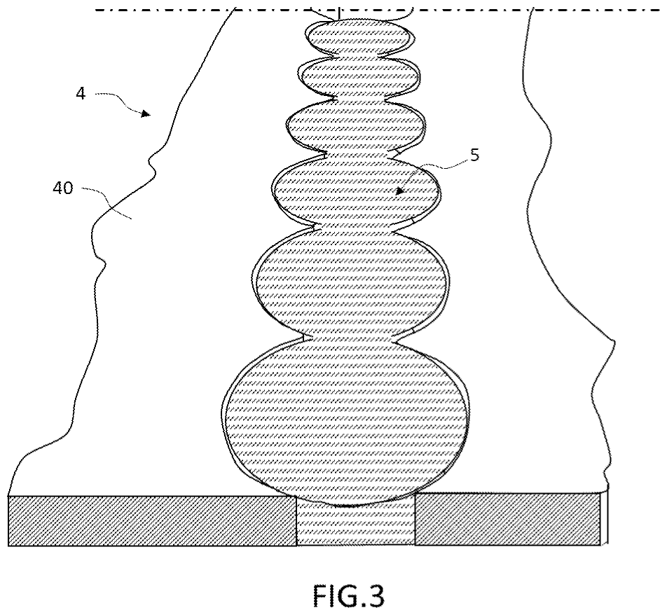

FIG. 3 represents an example embodiment of a guide wall 4, also called an accommodating structure comprising a one-piece element 5 comprising 6 cylindrical profiles. According to another case, the accommodating structure 4 can comprise two one-piece elements 5 chained together and bound by a bonding element. The bonding element may be arranged along an edge of an end of a one-piece element and may extend over its height or part of its height. According to one example, the bonding element can be provided by a slide connection, for example by means of a rail or a linear guide, a groove, a dovetail. The bonding can be ensured by translation sliding between two end profiles in each of the one-piece structures.

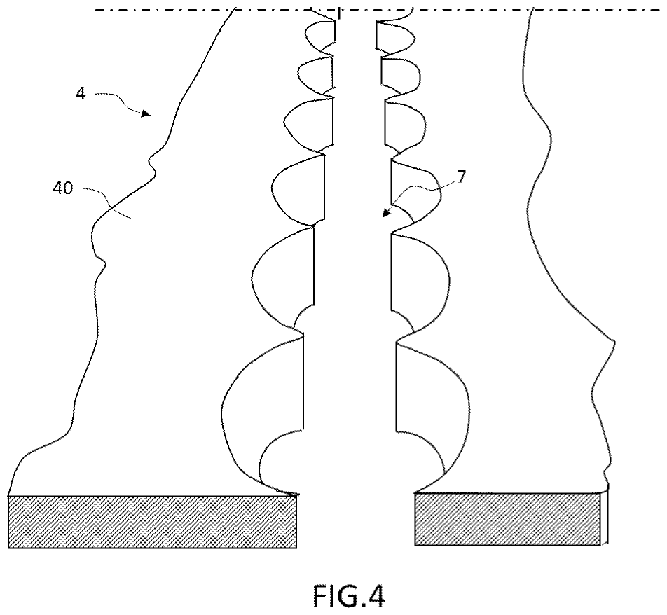

The accommodating structure 4 is represented without the one-piece element 5 forming the lost formwork in FIG. 4. FIGS. 5, 6 and 7 represent examples of one-piece elements.

The invention relates to a guide structure 4 including a one-piece element 5 of the invention defining a lost formwork. The accommodating structure 4 is obtained by a concrete pouring operation in a cavity made in the ground 1 in which at least one one-piece element 5 is positioned. The one-piece element 5 imposes the geometry of the accommodating structure 4 by molding. The operation can also be considered as counter molding because the one-piece element 5 is designed to define openings within the accommodating structure 4 by forming a lost formwork. Counter-molding is understood as a molding allowing space reservation dedicated to the guides within the poured concrete structure.

FIG. 5 represents a one-piece element 5 of the invention including a plurality of substantially cylindrical guides 10. The guides are secured together by means of a molding operation in a geometry in which the cylinders defining the guides are intersected.

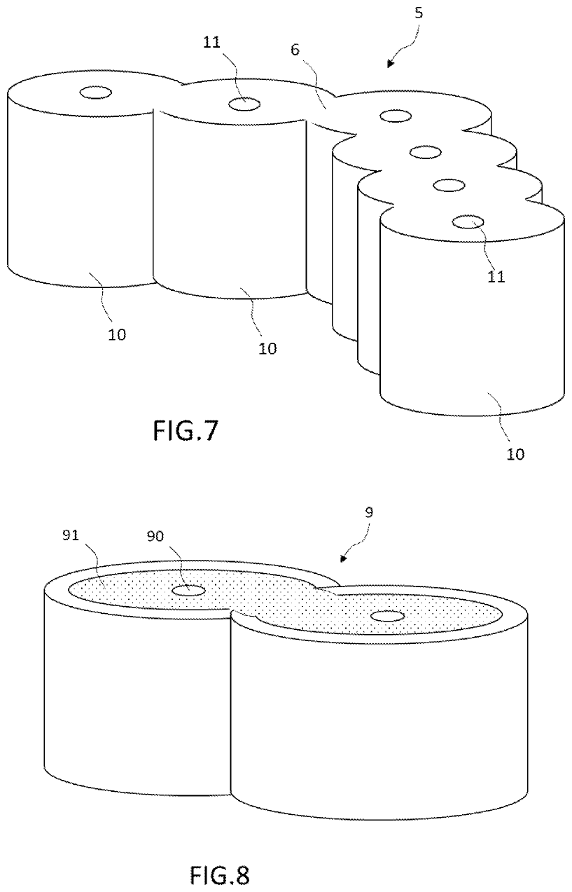

In its simplest form, the one-piece element 5 comprises only one cylindrical or substantially cylindrical profile. According to different embodiments, the accommodating structure 4 may comprise a plurality of intersected cylindrical profiles, such as 3, 4, 5 adjacent profiles two by two, or even 10 intersected profiles and in some cases more than 15 or 20 profiles. According to one embodiment, the profiles are intersected in linear segments connected to each other by profiles defining intersections of two segments. Different shapes can be obtained such as “L”, “U”, “T” or any other shape. FIG. 7 represents an exemplary embodiment in which the one-piece element 5 forms two bound segments defining an angle between them.

An accommodating structure 4 allows an installation to be kept intact despite strong coactivity, and to maintain control over altimetry of a platform. Such an accommodating structure reduces the uncertainty of human judgment, such as that of an operator checking the correct position of the tool during drilling. Such an accommodating structure dramatically increases drilling accuracy while saving time.

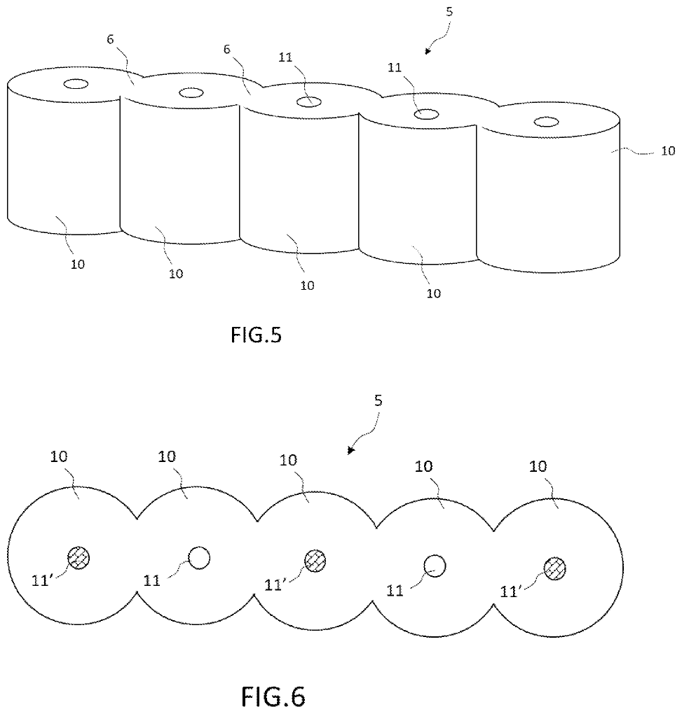

FIG. 6 represents a top view of the accommodating structure 5 of FIG. 5. In the examples of FIGS. 5 and 6, recessed central portions 11 for providing material reservation are represented. The reservation made advantageously makes it possible to transport the one-piece element 5 or to target the drill in the center of the cylindrical profile. Notations 11, 11′ represent in this example two different color markings to facilitate association of a hard or soft pile with the guide marking 10. However, the marking is preferably carried out by adding a colorant when manufacturing the one-piece element 5.

The material reservation further allows the surveyor to have a central mark on the formwork, to connect a lifting accessory at its center of gravity, to be attached through a metal strut or even to define a visual aid when positioning the drilling machine.

FIG. 8 represents a mold 9 of a one-piece element 5. In the exemplary case of FIG. 8, the mold includes two cavities for making a one-piece element comprising two intersected cylindrical profiles.

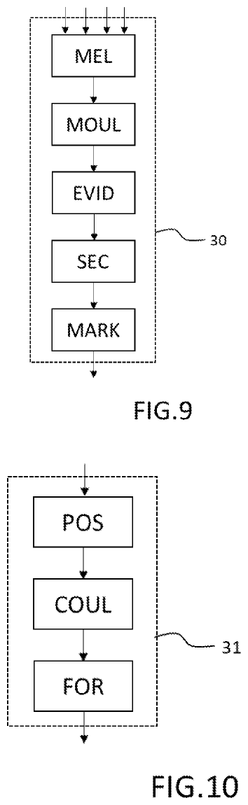

FIG. 9 represents an example of the method of the invention 30 for making a one-piece element 5.

The method 30 aims to make a one-piece element including an organic base such as straw. In the present invention, an organic base defines a plant or animal element substantially forming a rod. More specifically, the rod part of certain grasses, or more generally a vegetable straw, will be referred to as an organic base. According to one embodiment, the organic base is a base of plant origin.

According to one example, the one-piece element is made of earth-straw. The organic base may be straw, such as hemp straw, called hemp hurd, hay, horsehair or any other element for defining an organic base for the mixture to be made. According to one embodiment, the organic base includes plant fibers. According to one embodiment, the plant fibers are hemp fibers and/or flax fibers. According to one embodiment, the straw is a flax straw, i.e. a straw having mechanical properties increasing strength of the molded one-piece element. According to one embodiment, the flax is in the form of a flax shives. Shives are fragments of straw that are recovered during scutching. They account for about 50% of the entire plant. This arrangement is particularly advantageous because it allows the properties of flax to be enjoyed while using shives, which are by-products of the flax industry and therefore inexpensive.

The mixture also comprises a hydraulic binder formed by a volume of water and a volume of a bonding element, also called earth base. Different materials can be used to form the bonding element of the mixture. By way of example, raw earth, e.g. clay, may be used. When the soil does not contain clay, a volume of clay can be added, for example.

When raw earth is used, a first step aims to recover a first volume of earth preferably sieved with a particle size sufficiently fine to produce a homogeneous mixture.

However, other bonding elements may be used to act as a binder in the mixture. For example, mineral binders can be used. These elements are, for example, cement, plaster, lime or a mixture of the latter materials. This binder can be mixed with a volume of raw earth or used alone. According to one embodiment, the clay is used alone with water. According to the embodiments of the invention, a binder that does not achieve too much mechanical strength of the one-piece element 5 will be preferred. In this case, lime makes a more aerated and brittle one-piece element 5 during the drilling operation. According to one embodiment, the binder used is blast furnace slag. Blast furnace slag corresponds to mill scale that is formed during liquid melting or metalworking. It is a mixture mainly comprised of silicates, aluminates and lime, with various metal oxides, except iron oxides. Blast furnace slag is a particularly advantageous binder because it provides the mechanical holding and setting properties while being inexpensive as a by-product of the metalworking industry. According to one embodiment, the blast furnace slag is used in combination with another binder, such as cement, lime or plaster.

According to one embodiment, a volume of straw and a volume of water are added gradually while kneading the mixture. A mixing step is noted MEL in FIG. 9. The choice of straw and its addition to the mixture are preferably carried out in such a way as to obtain an aerated and homogeneous mixture. For example, the straw can be watered while mixing. A hemp straw retains water and forms a compact structure.

According to one example, a mixture may include in volume proportion 22 L of water, 20 L of lime, 10 L of plaster, 50 L of hemp hurd.

According to one embodiment, the mixture comprises a volume of organic base that is flax. Flax has mechanical properties advantageously increasing strength of the one-piece element 5 formed. According to one embodiment, the flax is in the form of flax straw.

According to one example, the mixture comprises a volume of 20 liters of cement or clay, 20 liters of blast furnace slag, 50 liters of water and 200 liters of flax straw or flax shives.

According to an exemplary embodiment, a colorant may be added during mixing, the mixture being then distributed into given molds or parts of a mold so as to obtain an alternation of cylindrical profiles having alternating colors.

According to another embodiment, the colorant may be added during molding such that the chosen color is properly associated in the cylindrical-shaped mold alternately with another cylindrical-shaped mold when the one-piece element includes several cylindrical profiles.

The mixture is then poured into a mold of suitable dimensions to form appropriate guides to make the guide walls. A step MOUL is represented in the diagram of FIG. 9. A particularly interesting geometry is a succession of intersected cylindrical profiles whose centers are spaced by some predefined distance as is represented in the cavity 91 of the mold 9. The mold 9 defines a cylindrical profile intersected with another cylindrical profile.

According to one embodiment, the cylindrical guides defining the mold are tangent to each other two by two. According to another example, the cylindrical guides defining the mold are distant by a predefined distance, for example a few centimeters, 5 cm or 10 cm according to examples.

According to one embodiment, the method of the invention comprises a recessing step EVID allowing a volume of material to be reserved in the one-piece element molded.

Recessing may be made during molding by integrating a full volume, such as rods 90 represented in FIG. 8, into the mold 9 allowing to reserve space in the one-piece element 5 obtained. Advantageously, recessing is made in the center of one of the faces of the cylindrical profile of the one-piece element 5. This recessing facilitates removal of the one-piece element from the guide wall when a removal is performed. According to another example, recessing makes it possible to easily transport the one-piece element 5 by means of the insertion of a holding rod, for example manipulated by a construction site apparatus.

According to another example, recessing allows insertion of a metal strut so that the accommodating structure is held during drilling.

According to another example, recessing allows inserting a physical marking that can also be destroyed during drilling.

The molded or formed material from water, raw earth and/or cement and/or lime and/or plaster and an organic base volume such as straw, is then dried. The drying operation can be performed in the open air. A drying operation SEC is noted in FIG. 9.

According to one example, a coloring step MARK makes it possible to make one-piece elements comprising a succession of identifiable alternating profiles, i.e. with markings of different colors. Marking can be carried out in different ways. A first way is to add a colorant during the manufacture of the one-piece element 5. A first colorant may be added to a mixture in a first profile and a second colorant may be added to a mixture in a second profile adjacent to the first profile and thus one profile out of two. This method has the advantage of releasing chips, portions, dust or pieces of the color of the colorant during drilling. Thus, the alternation of primary and secondary piles can be ensured by visual recognition of a color that emerges during drilling. This solution allows for easy control during drilling.

According to another manner, marking can be carried out by adding an indication on all or part of the upper surface of a cylindrical profile, for example after making a one-piece element 5. According to an example, this may be sprayed paint.

FIG. 10 represents an example of the method 31 of the invention for drilling an opening in the ground in order to insert a pile of a retaining wall. The method 31 comprises a first step of positioning the one-piece element 5 in a cavity made on the ground. The one-piece element 5 is positioned in such a way that the centers of each cylindrical profile correspond to the pre-set drilling axes. The one-piece element 5 is then held in position and a pouring operation of a volume of concrete is performed. The pouring is carried out in the cavity where the one-piece element is inserted so that the concrete occupies the space between the border of the cavity and the wall of the one-piece element 5. The pouring of the concrete 40 is carried out until a sufficient structure height is obtained to obtain a stabilized accommodating structure 4 and allowing guidance of a plurality of drillings to be carried out.

When the pouring operation is carried out, the concrete is dried in order to complete the accommodating structure 4 definitively. A construction site apparatus, such as that represented in FIG. 2, is then positioned in proximity to the accommodating structure to carry and guide an auger 2, 3 in vertical alignment with a guide 10 of the one-piece element 5. Preferably, a positioning of the center of the auger axis is aligned with the marking of a guide 10 of a one-piece element 5.

Drilling is then carried out, the auger penetrating one of the guides pierces the guide and expels fragments thereof. The material formed by the one-piece element 5 is sufficiently brittle or friable to allow drilling. One advantage is to remove the guide withdrawal state while still allowing drilling. When a removal is made before drilling, the guides 10 of the one-piece element 5 are easily recyclable because they are biodegradable, or even reusable as a material to make other works. One advantage of the central cavity made in each guide 10 is that it allows either to facilitate the removal operation before drilling, or to integrate an additional guiding element such as a marking made directly on the guide or on an element inserted into the reservation.

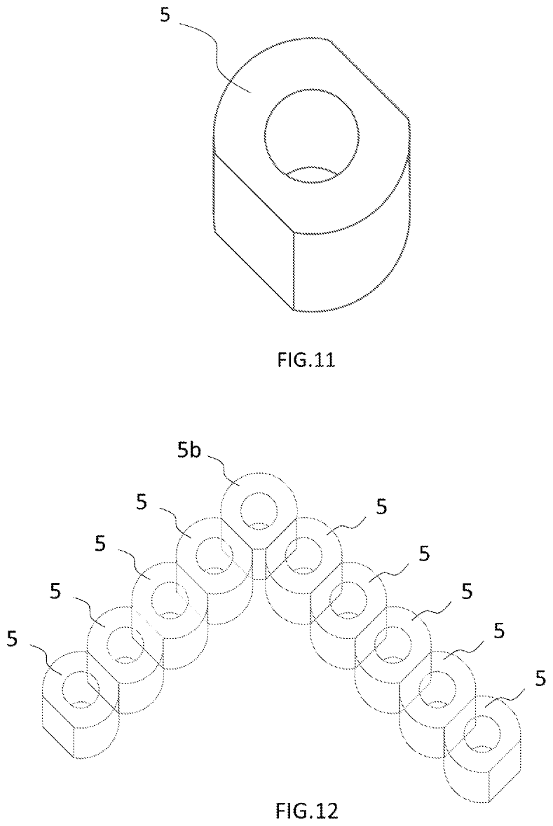

According to one embodiment, and as represented in FIG. 11, the mold 9 is adapted for molding a one-piece element 5 adapted to guide drilling of a single pile P₁. The one-piece element 5 includes a generally circular transverse cross-section which includes two cut-outs along tangents of the circle forming the circular cross-section. The two tangents are preferably parallel to each other. One advantage conferred by this shape for the one-piece element 5 is to allow arrangement of several one-piece elements 5 in line in order to perform molding of the guide wall and to allow guidance of several pile drillings. When the cut-outs are parallel to each other, a cut-out of a one-piece element is brought into contact with a cut-out of another one-piece element 5 to form a straight line of one-piece elements. One advantage of having several one-piece elements each adapted to the drilling of a single pile is to facilitate installation on site by allowing easy movement of one one-piece element as it has a relatively small size. Another advantage is to provide modularity in the geometry of one-piece element lines once they are installed. In this way, the number of one-piece elements 5 required to make the length of the guide wall 4 to be poured can be chosen. According to one embodiment, the two cut-outs of the one-piece element 5 are not parallel to each other. In other words, they form an angle to each other. This arrangement allows an angle to be formed between two rows of one-piece elements 5 once they are installed. One example of such an embodiment is shown in FIG. 12. On this, a set of one-piece elements 5 form a first line 50 for pouring a straight guide wall. A second set of one-piece elements 5 forms a second line that is perpendicular to the first line of one-piece elements. A corner single-piece element 5b is located at the intersection of the two lines. In this case, the two cut-outs of the corner single-piece element 5b are oriented along lines perpendicular to each other. In this way, it is possible to lay a corner one-piece element 5b between two straight lines of one-piece elements so that these are perpendicular to each other. This arrangement makes it easy to adjust geometry of the guide walls to the architecture of the work to be made.

According to one embodiment, the cut-outs of the one-piece element 5 are oriented along lines forming an angle close to 45 degrees to each other, preferably 45 degrees. In this way, a corner one-piece element 5b can be placed between two lines of one-piece elements forming an angle of 45 degrees to each other. According to one embodiment, the cut-outs of the angle one-piece element 5b are oriented along lines forming an angle between 10 degrees and 45 degrees to each other. Advantageously, several corner one-piece elements 5b can be placed consecutively. This arrangement advantageously makes it possible to form a series of corner one-piece elements which are placed in an arc of circle or in a curve. This arrangement allows to follow any geometry of the architecture of the work to be made.

According to one embodiment, the cylindrical portion of the one-piece element 5 comprises a cross-section having a polygon shape. According to one embodiment, the cross-section has a polygon shape with 3, four, five, six, seven, eight, nine or ten sides. According to one embodiment, the cross-section has a hexagon shape. The hexagon shape is particularly advantageous because it allows a same form of a one-piece element to be used to make straight lines of one-piece elements 5 and to make angles by using as a contact surface between two one-piece elements parts that have an angle between them. In other words, the hexagon shape corresponds to a circular cross-section in which six cut-outs are made. Thus, the user can choose which cut-outs of each successive one-piece element 5 they contact in a series of one-piece elements 5. In this way, the successive one-piece elements can be placed in a straight line, or form an angle between two straight lines, or in a curve.

According to one embodiment, when making the accommodating structure 4 forming a guide wall, several one-piece elements 5 can be superimposed on one another. In this way, one, two, or three, four, five one-piece elements 5 can be superimposed on each other. This arrangement makes it possible to increase height of the cavities 7 occupied by the one-piece elements. Advantageously, this arrangement makes it possible to obtain a same height of the cavity 7 while having one-piece elements 5 that have a height and therefore a weight reduced. This arrangement is therefore particularly advantageous for easier installation and handling of lighter one-piece elements.

According to one embodiment, the one-piece elements 5 are placed in the accommodating structure 4 so that each is in contact with the next one-piece element. In this case, the one-piece elements include the cut-outs allowing subsequently formed piles that are secant. By secant piles, it is meant piles with a circular base and which include side cut-outs that are in contact between a pile and the pile located directly in proximity thereto. Such secant piles are illustrated in FIG. 1.

According to one embodiment, the one-piece elements 5 are placed in the accommodating structure 4 so that each is in contact with the next one-piece element. In this case, the one-piece elements have a circular cross-section. In this way, the one-piece elements 5 allow tangent piles to be formed in the accommodating structure. By tangent piles, it is meant piles of circular cross-section in contact with each other.

According to one embodiment, the one-piece elements 5 are placed in the accommodating structure 4 so as to be distant from each other. According to this embodiment, each one-piece element is distant by a distance of 10 cm from the next one-piece element. In this way, the one-piece elements 5 enable distant piles to be formed in the accommodating structure. The distance between each pile can be adapted according to the construction needs and can therefore be less than or more than 10 cm.

1. A method for manufacturing a one-piece element defining a lost formwork for forming a target and/or a drilling guide, the method comprising:
mixing a volume of hydraulic binder including a first volume of water and a second volume of a bonding element with a volume of an organic base to obtain a mixture;
molding said mixture to obtain a one-piece element including at least one cylindrical portion with a radius of at least 40 cm,
drying said mixture molded forming a one-piece element.

2. The manufacturing method according to claim 1, further comprising recessing material from a central portion of the one-piece element in a central zone of the at least one cylinder portion to form a guide.

3. The manufacturing method according to claim 1, further comprising cutting the one-piece element, said cutting allowing a predetermined shape to be obtained.

4. The manufacturing method according to claim 1, further comprising assembling a plurality of one-piece elements together in order to produce a guide wall, said one-piece elements comprising bonding elements in order to secure two ends of two one-piece elements together.

5. The manufacturing method according to claim 1, wherein the molding of the one-piece element is carried out by a mold for forming at least one guide whose centers of the cylindrical portions considered together form a characteristic geometry.

6. The manufacturing method according to claim 1, wherein adjacent cylindrical portions of a one-piece element are distant by a predefined distance, tangent to each other or intersected on a portion of their radius.

7. The manufacturing method according to claim 1, wherein the mixture comprises:
volume of water in a volume proportion of the mixture between 15 and 27%;
a volume of lime and/or plaster and/or cement and/or blast furnace slag forming a bonding element in a volume proportion of the mixture between 20% and 40%;
a volume of straw forming an organic base in a volume proportion of the mixture between 33% and 65%.

8. The manufacturing method according to claim 1, further comprising coloring each cylindrical profile of a mixture to form a one-piece element having an alternating coloration between two adjacent cylindrical profiles.

9. A one-piece element to define a lost formwork obtained by the method according to claim 1.

10. A method comprising providing a one-piece element to define a lost formwork, said one-piece element being formed by a mixture of a volume of hydraulic binder comprising a first volume of water and a second volume of a bonding element and a volume of an organic base, said one-piece element forming at least a cylindrical portion, said method comprising forming a concrete accommodating structure for accommodating a pile wall.

11. A method comprising providing at least one one-piece element to define a target and a drilling guide, said at least one one-piece element being formed by a mixture of a volume of hydraulic binder comprising a first volume of water and a second volume of a bonding element and a volume of an organic base, said at least one one-piece element forming at least one cylindrical portion, said method including the arrangement of said at least one one-piece element in a concrete accommodating structure for receiving piles, said drilling being carried out by an auger whose head is applied to a surface of said at least one one-piece element.

12. The use method according to claim 10, wherein the mixture comprises:
a volume of water in a volume proportion of the mixture between 15 and 27%;
a volume of lime and/or plaster and/or cement and/or blast furnace slag forming a bonding element in a volume proportion of the mixture between 20% and 40%;
a volume of straw forming an organic base in a volume proportion of the mixture between 33% and 65%.

13. An accommodating structure forming a guide wall for making a pile wall comprising a concrete base and cavities, said cavities being occupied by at least one one-piece element formed by a mixture of a volume of hydraulic binder comprising a first volume of water and a second volume of a bonding element and a volume of an organic base.

14. The accommodating structure according to claim 13, wherein the mixture of the at least one one-piece element comprises:
a volume of water in a volume proportion of the mixture between 15 and 27%;
a volume of lime and/or plaster and/or cement and/or blast furnace slag forming a bonding element in a volume proportion of the mixture between 20% and 40%;
a volume of straw forming an organic base in a volume proportion of the mixture between 33% and 65%.

15. The manufacturing method according to claim 5, wherein the characteristic geometry is a line, a curve, a T shape or an L shape.
